(19) United States
(12) Patent Application Publication
(10) Pub. No.: US 2021/0234823 A1
(43) Pub. Date: Jul. 29, 2021

(54) DETECTING AND IDENTIFYING TOXIC AND OFFENSIVE SOCIAL INTERACTIONS IN DIGITAL COMMUNICATIONS

(71) Applicant: Antitoxin Technologies Inc., Palo Alto, CA (US)

(72) Inventors: Zohar Levkovitz, Palo Alto, CA (US); Ron Porat, Tel-Mond (IL); Hemi Pecker, Haifa (IL); Yaakov Schwartzman, Petach Tikva (IL); Hezi Stern, Even-Yehuda (IL); Doron Habshush, Tel-Aviv (IL); Arik Cohen, Jerusalem (IL)

(73) Assignee: Antitoxin Technologies Inc., Palo Alto, CA (US)

(21) Appl. No.: 16/780,966

(22) Filed: Feb. 4, 2020

Related U.S. Application Data
(60) Provisional application No. 62/966,059, filed on Jan. 27, 2020.

(51) Int. Cl. H04L 12/58; G06F 40/35; G06Q 50/26

(52) U.S. Cl. CPC H04L 51/32; H04L 51/18; G06Q 50/26; H04L 51/10; G06F 40/35

(57) ABSTRACT

A system for processing digital data signals, comprising at least one hardware processor adapted for identifying an offending social interaction by: receiving at least one signal from at least one other hardware processor, where each of the at least one signal is generated according to an action of a person and is associated with at least some of a plurality of entities, each entity having a plurality of basic entity confidence values of a plurality of basic entity attributes, and a plurality of combination entity confidence values of a plurality of combination entity attributes; and for at least one entity of the plurality of entities: updating at least one basic entity confidence value thereof according to a plurality of signal attribute values computed for the at least one signal; updating at least one combination entity confidence value thereof according to a relationship tree describing a semantic relationship.

### RELATED APPLICATION

This application claims the benefit of priority under 35 USC § 119(e) of U.S. Provisional Patent Application No. 62/966,059 filed on Jan. 27, 2020. The contents of the above application are incorporated by reference as if fully set forth herein in their entirety.

### FIELD AND BACKGROUND OF THE INVENTION

The present invention, in some embodiments thereof, relates to processing digital data signals and, more specifically, but not exclusively, to a system for processing digital data signals related to social interactions.

A wide area of digital technologies is increasingly being used for social interactions, including digital communication networks, social network services, for example Facebook, Instagram, Snapchat, and Twitter, messaging services, for example WhatsApp, gaming platforms, for example Fortnite, online communities (forums), blogs, and file sharing, for example via a web site. Some social interactions using digital technologies include sharing, distributing and exchanging digital content, for example digital images, digital video and digital audio. Some social interactions using digital technologies include exchanging text messages.

Some social interactions using digital technologies have allowed creating communities where individuals participating in a community interact in a manner that is supportive of the community. For example, a WhatsApp group allowing a group of friends to communicate, and a forum supporting bereaving individuals. However, as use of digital technologies for social interaction has increased, so has increased the use of digital technologies for offending social interactions. Digital technologies are known to be used by some people to make other people feel angry, sad, or scared. In addition, digital technologies are known to be used to perpetrate socially unacceptable, and occasionally illegal, behavior, for example racism, offering an illegal substance such as alcohol or an identified drug, offering gambling, solicitation, pornography and pedophilia.

Digital-technology-enabled social interactions involving children are also increasing in prevalence. For example, some children interact with their peers using social media platforms, for example WhatsApp groups. Other examples of social interactions involving children include a child playing network connected games, for example Fortnite, a child accessing an online community, and a child browsing one or more web sites on the Internet. As a result, there is an increase in an amount of children adversely effected by social interactions, for example by being bullied using digital technologies, or by having an interaction with a sexual predator via digital technologies. In addition, some children use digital technology to share an intention to inflict self-harm or to confess substance abuse, for example in a chat group or on a social media personal page.

There is an increasing amount of evidence linking exposure of a child to offending social interactions to an increase in a likelihood of the child to engage in self-harm and a likelihood of the child to attempt suicide. In addition, there is an increasing amount of evidence linking exposure of a child to offending social interactions to an increase in long term effects including a likelihood of the child to engage in substance abuse, a likelihood of the child to commit non-violent crime, reduced physical safety of the child at school, and a reduction in the child's motivation to apply themselves to school work and extracurricular activity.

There is a need to identify offending social interactions on digital technology based platforms, to reduce an amount of adverse effects of such offending social interactions.

### SUMMARY OF THE INVENTION

It is an object of the present invention to provide a system and method for identifying offending social interactions in digital data signals.

The foregoing and other objects are achieved by the features of the independent claims. Further implementation forms are apparent from the dependent claims, the description and the figures.

According to a first aspect of the invention, a system for processing digital data signals comprises at least one hardware processor adapted for identifying an offending social interaction by: receiving at least one signal from at least one other hardware processor, where each of the at least one signal is generated according to an action of a person and is associated with at least some of a plurality of entities, each entity having a plurality of basic entity confidence values of a plurality of basic entity attributes, and a plurality of combination entity confidence values of a plurality of combination entity attributes; and for at least one entity of the plurality of entities: updating at least one basic entity confidence value thereof according to a plurality of signal attribute values computed for the at least one signal; updating at least one combination entity confidence value thereof, using the plurality of basic entity confidence values and the plurality of combination entity confidence values thereof, according to a relationship tree describing a semantic relationship between the plurality of basic entity attributes and the plurality of combination entity attributes; determining at least one offending social interaction subject to the at least one combination entity confidence value exceeding a threshold confidence value; and performing at least one management task subject to determining the at least one offending social interaction.

According to a second aspect of the invention, a method for processing digital data signals comprises identifying an offending social interaction by: receiving at least one signal from at least one hardware processor, where each of the at least one signal is generated according to an action of a person and is associated with at least some of a plurality of entities, each entity having a plurality of basic entity confidence values of a plurality of basic entity attributes, and a plurality of combination entity confidence values of a plurality of combination entity attributes; and for at least one entity of the plurality of entities: updating at least one basic entity confidence value thereof, using the plurality of basic entity confidence values and the plurality of combination entity confidence values thereof, according to a plurality of signal attribute values computed for the at least one signal; updating at least one combination entity confidence value thereof according to a relationship tree describing a semantic relationship between the plurality of basic entity attributes and the plurality of combination entity attributes; determining at least one offending social interaction subject to the at least one combination entity confidence value exceeding a threshold confidence value; and performing at least one management task subject to determining the at least one offending social interaction.

According to a third aspect of the invention, a monitoring system comprises at least one hardware processor adapted for: receiving from at least one other hardware processor an indication of an offending social interaction, identified by: receiving at least one signal from the at least one hardware processor, where each of the at least one signal is generated according to an action of a person and is associated with at least some of a plurality of entities, each entity having a plurality of basic entity confidence values of a plurality of basic entity attributes, and a plurality of combination entity confidence values of a plurality of combination entity attributes; and for at least one entity of the plurality of entities: updating at least one basic entity confidence value thereof according to a plurality of signal attribute values computed for the at least one signal; updating at least one combination entity confidence value thereof, using the plurality of basic entity confidence values and the plurality of combination entity confidence values thereof, according to a relationship tree describing a semantic relationship between the plurality of basic entity attributes and the plurality of combination entity attributes; determining at least one offending social interaction subject to the at least one combination entity confidence value exceeding a threshold confidence value; and sending at least one message comprising an indication of the at least one offending social interaction; and declining sending at least one other additional signals associated with the at least one entity.

With reference to the first and second aspects, in a first possible implementation of the first and second aspects of the present invention the at least one combination entity confidence value is updated according to the relationship tree at an identified time, at least some of the respective plurality of basic entity confidence values and the respective plurality of combination entity confidence values contributing to updating the at least one combination entity confidence value according to the relationship tree are each updated to exceed a threshold confidence value at one or more times in an identified time interval preceding the identified time.

Updating the at least one combination entity confidence value according to one or more of the plurality of basic entity confidence values and the plurality of combination entity confidence values updated at one or more times preceding updating the at least one combination entity confidence value facilitates identifying an offending nature of a social interaction where the offense is progressive and comprises a plurality of occurrences over time, increasing accuracy of identifying an offending social interaction compared to other methods that consider only simultaneous occurrences.

With reference to the first and second aspects, in a second possible implementation of the first and second aspects of the present invention the at least one combination entity confidence value exceeding the threshold confidence value comprises a combination hunter confidence value indicative of a likelihood of a social interaction associated with the at least one entity comprises a sender person actively seeking a target person. Optionally, the plurality of basic entity confidence values comprises at least one location confidence value selected from: a home location confidence value, indicative of a degree of confidence of identifying, in at least one signal comprising text, a geographical location of a residence; a school location confidence value, indicative of a degree of confidence of identifying, in the at least one signal comprising text, a geographical location of a school attended by the target person; and a general location confidence value, indicative of a degree of confidence of identifying, in the at least one signal comprising text, a geographical location for a meeting.

Optionally, the plurality of basic entity confidence values comprises a real life meeting confidence value, indicative of a likelihood of identifying, in the at least one signal comprising text, a request for a meeting in real life. Updating a confidence value indicative of a likelihood of identifying a hunter according to identifying a location and additionally or alternatively a request to meet in real life increases accuracy of a confidence value that a social interaction comprises a hunter, thus increasing accuracy of identifying an offending social interaction. Optionally, updating the at least one combination entity confidence value according to the relationship tree comprises updating the combination hunter confidence value subject to the location confidence value and the real life meeting confidence value each exceeding the threshold confidence value. Optionally, the combination hunter confidence value is updated according to the relationship tree at an identified time, and the location confidence value and the real life meeting confidence value are each updated to exceed the threshold confidence value at one or more times in an identified time interval preceding the identified time.

Optionally, the plurality of basic entity confidence values further comprises a location-coordinates confidence value indicative of a likelihood of identifying, in the at least one signal comprising text, one or more coordinates in an identified coordinate system, and updating the at least one combination entity confidence value according to the relationship tree comprises updating the combination hunter confidence value further subject to the location-coordinates confidence value exceeding the threshold confidence value. Updating the combination hunter confidence value according to a confidence value indicative of identifying coordinates in a coordinate system increases accuracy of the combination hunter confidence value, thus increases accuracy of an identification of an offending social interaction comprising a hunter. Optionally, the location-coordinates confidence value is updated to exceed the threshold confidence value at another time in the identified time interval preceding the identified time.

With reference to the first and second aspects, in a third possible implementation of the first and second aspects of the present invention the at least one combination entity confidence value exceeding the threshold confidence value comprises a combination pedophile confidence value indicative of a likelihood of another social interaction associated with the at least one entity having a sexual nature and comprising an adult person and a child person. Optionally, the plurality of basic entity confidence values comprises at least one sexual-content confidence value selected from: a sexting confidence value, indicative of a degree of confidence of identifying, in at least one signal comprising text, text having a sexual nature; a sexual-solicitation confidence value, indicative of a degree of confidence of identifying, in the at least one signal comprising text, text having a sexual solicitation nature; and a private-parts confidence value, indicative of a degree of confidence of identifying, in the at least one signal comprising text, text describing at least one body part in a set of private body parts.

Optionally, the plurality of basic entity confidence values comprises at least one sexual-content-request confidence value selected from: a camera-request confidence value, indicative of a degree of confidence of identifying, in at least one signal comprising text, a request to activate a digital camera; and an image-request confidence value, indicative of a degree of confidence of identifying, in the at least one signal comprising text, a request to send one or more digital images. Optionally, the plurality of combination entity confidence values comprises: a combination sender-age confidence value, indicative of a likelihood that an age of the adult person is greater than or equal to a sender age minimum value; and a combination target-age confidence value, indicative of a likelihood that another age of the child person is less than or equal to a target age maximum value.

Optionally, updating the at least one combination entity confidence value according to the relationship tree comprises updating the combination pedophile confidence value subject to the at least one sexual-content confidence value, the at least one sexual-content-request confidence value, the combination sender-age confidence value, and the combination target-age confidence value each exceeding the threshold confidence value. Updating a combination pedophile confidence value according to one or more sexual-content confidence values, one or more sexual-content-request confidence values, a combination sender-age confidence value and a combination target-age confidence value increases accuracy of a combination pedophile confidence value, increasing accuracy of identifying an offending social interaction comprising a pedophile.

Optionally, the combination pedophile confidence value is updated according to the relationship tree at yet another identified time, and the sexting confidence value, the sexual-solicitation confidence value, the private-parts confidence value, the camera-request confidence value, and the image-request confidence value are each updated to exceed the threshold confidence value at yet one or more other times in yet another identified time interval preceding the yet other identified time. Optionally, the plurality of basic entity confidence values further comprises at least one of: a sexual-activity confidence value indicative of a likelihood of identifying sexual activity in at least one other signal comprising at least one digital image; and a nudity confidence value indicative of a likelihood of identifying nudity in the at least one other signal comprising the at least one digital image. Optionally, updating the at least one combination entity confidence value according to the relationship tree comprises updating the combination pedophile confidence value further subject to at least one of the sexual-activity confidence value and the nudity confidence value exceeding the threshold confidence value.

Updating the combination pedophile confidence value according to one or more basic entity confidence values indicative of sexual activity and additionally or alternatively nudity identified in one or more digital images increases accuracy of the combination pedophile confidence value and increases accuracy of identifying an offending social interaction comprising a pedophile. Optionally, the plurality of basic entity confidence values further comprises: an explicit-sender-age confidence value indicative of a likelihood that an age of a person identified in the at least one signal comprising text is greater than or equal to the sender age minimum value; and an explicit-target-age confidence value indicative of a likelihood that another age of another person identified in the at least one signal comprising text is less than or equal to the target age maximum value.

Optionally, updating the at least one combination entity confidence value according to the relationship tree comprises at least one of: updating the combination sender-age confidence value subject to the explicit-sender-age confidence exceeding a sender-age confidence threshold; and updating the combination target-age confidence value subject to the explicit-target-age confidence exceeding a target-age confidence threshold. Using one or more basic entity confidence values indicative of a likelihood that a sender person is above an identified minimum age and additionally or alternatively that a target person is below an identified maximum age increases an accuracy of the combination pedophile confidence value, increasing accuracy of identifying an offending social interaction comprising a pedophile.

Optionally, the plurality of basic entity confidence values further comprises: an age readability confidence value indicative of a degree of confidence of identifying, in the at least one signal comprising text, an age according to a readability classification of the text; and an under-age-query confidence value indicative of a degree of confidence of identifying, in the at least one signal comprising text, a query for determining a person's age. Optionally, updating the at least one combination entity confidence value according to the relationship tree comprises at least one of: updating the combination sender-age confidence value subject to the age readability confidence value exceeding the threshold confidence value; and updating the combination target-age confidence value subject to the under-age-query confidence value exceeding the threshold confidence value.

Updating a confidence value in a person's age according to identifying a query for determining a person's age and additionally or alternatively according to a readability classification of text of a signal increases accuracy of the confidence value in the person's age, thus increasing accuracy of a combination pedophile confidence value computed using the confidence value and thus increasing accuracy of identifying an offending social interaction comprising a pedophile. Optionally, the plurality of basic entity confidence values further comprises at least one visual-age confidence value indicative of a likelihood of identifying an age of at least one person identified in at least one other signal comprising at least one digital image, and updating the at least one combination entity confidence value according to the relationship tree comprises at least one of: updating the combination sender-age confidence value subject to the at least one visual-age confidence value exceeding a sender-age confidence threshold; and updating the combination target-age confidence value subject to the at least one visual-age confidence value exceeding a target-age confidence threshold. Updating a confidence value in a person's age according to a confidence in identifying the person's age in one or more digital images of a signal increases accuracy of the confidence value in the person's age, thus increasing accuracy of a combination pedophile confidence value computed using the confidence value and thus increasing accuracy of identifying an offending social interaction comprising a pedophile.

With reference to the first and second aspects, in a fourth possible implementation of the first and second aspects of the present invention the at least one combination entity confidence value exceeding the threshold confidence value comprises a combination predator confidence value indicative of a likelihood of a social interaction associated with the at least one entity comprising an adult sender person actively seeking a target minor person. Optionally, the plurality of combination entity confidence values comprises a combination hunter confidence value indicative of a likelihood of the social interaction comprising the adult sender person actively seeking the target minor person, and a combination pedophile confidence value indicative of a likelihood of the social interaction having a sexual nature and comprising the adult sender person and the target minor person.

Optionally, updating the at least one combination entity confidence value according to the relationship tree comprises updating the combination predator confidence value subject to the combination hunter confidence value and the combination pedophile confidence value each exceeding the threshold confidence value. Updating a combination predator confidence value according to a combination hunter confidence value and a combination pedophile confidence value increases accuracy of the combination predator confidence value, thus increasing accuracy of identifying an offending social interaction comprising a predator. Optionally, the combination predator confidence value is updated according to the relationship tree at an additional other identified time, and the combination hunter confidence value, and the combination pedophile confidence value are each updated to exceed the threshold confidence value at one or more additional other times in an additional other identified time interval preceding the additional other identified time.

With reference to the first and second aspects, in a fifth possible implementation of the first and second aspects of the present invention updating the at least one combination entity confidence value comprises executing at least one combination classifier trained to compute at least one combination classification in response to a plurality of basic entity confidence values and another plurality of combination entity confidence values. Optionally, the plurality of signal attribute values are computed by executing at least one signal classifier, trained to compute at least one signal classification in response to at least one input signal. Using one or more combination classifiers and additionally or alternatively one or more signal classifiers increases accuracy of the plurality of signal attribute values and additionally or alternatively of the plurality of combination entity confidence values, thus increasing accuracy of identification of an offending social interaction according thereto.

With reference to the first and second aspects, in a sixth possible implementation of the first and second aspects of the present invention performing the at least one management task comprises at least one of: instructing at least one other hardware processor, connected to the at least one hardware processor, to decline sending one or more other additional signals associated with the at least one entity; instructing at least one additional other hardware processor, connected to the at least one hardware processor, to generate an alarm perceivable by a person monitoring an output of the at least one additional other hardware processor; sending a message to the at least one other hardware processor; storing an indication of the at least one offending social interaction on at least one non-volatile digital storage connected to the at least one hardware processor; and displaying another message on one or more display devices connected to the at least one hardware processor.

Instructing to decline sending one or more other additional signals, and additionally or alternatively generating an alarm perceivable by a person and additionally or alternatively sending a message to one or more other hardware processors, increases usability of a system implemented according to the present invention compared to another system that outputs an indication without performing any other task.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic block diagram of an exemplary system, according to some embodiments of the present invention;

FIG. 2 is a flowchart schematically representing an optional flow of operations, according to some embodiments of the present invention;

FIG. 3 is a schematic block diagram of part of an exemplary relationship tree, according to some embodiments of the present invention; and

FIG. 4 is a flowchart schematically representing an optional flow of operations for a monitoring system, according to some embodiments of the present invention.

### DESCRIPTION OF SPECIFIC EMBODIMENTS OF THE INVENTION

The present invention, in some embodiments thereof, relates to processing digital data signals and, more specifically, but not exclusively, to identifying offending social interactions in digital data signals.

As used herein, the term “toxic behavior” refers to behavior of one or more people for the purpose of causing harm to themselves and additionally or alternatively to one or more other people's physical health and additionally or alternatively emotional well-being.

For brevity, henceforth the term “signal” is used to mean a digital data signal and the terms are used interchangeably.

The following description focuses on offending behavior targeted at children, however the present invention is not limited to detecting offending behavior targeted at children and may be applied to detecting offending behavior targeted at other targets, for example women, members of a social minority, or any individual target.

Additionally, for brevity, the term “digital platform” is henceforth used to mean any platform based on digital technology, including but not limited to digital communication networks, social network services, messaging services, gaming platforms, online communities (forums), blogs, file sharing sites, and web sites.

It may be the case that an unacceptable social interaction is obvious from a single utterance or a single exchange of information, for example an explicit threat directed at a particular individual. However, there are cases where the unacceptable nature of a social interaction is evident from an accumulation of a plurality of utterances, exchanges of data, or both. For example, one child using a pejorative expression towards another child may be unpleasant, but does not necessarily raise concern for longer term implications. Shaming, is publication of private information with the intention to cause embarrassment or humiliation. Using the pejorative expression in the presence of a third child may be a form of shaming, which may have further implications. Bullying is behavior seeking to harm, intimidate or coerce a target person or persons. An accumulation of a plurality of children each using the pejorative expression towards the other child may be a form of bullying, even though each one considered individually may not raise concern for longer term implications.

In another example, an offensive social interaction may include grooming, where a person establishes an emotional connection with another person for the purpose of exploiting the other person, some examples being engaging the other person in prostitution, engaging the other person in pornography and sexually abusing the other person. Such grooming usually includes a plurality of apparently benign utterances, which when viewed as a whole reveal the unacceptable nature of the social interaction.

Social interactions on digital platforms comprise generation of a plurality of digital signals, each generated according to an action of one or more persons. For example, when a person uploads a video, a digital video is generated on the platform. In another example, a person sending a message in a chat group results in generating a digital signal comprising the message. In another example an application executing on a person's device, for example a person's smartphone, periodically generates a signal indicative of the person's location and sends the signal to another hardware processor, for example a platform server. In another example, when a user accesses a universal resource location (URL) via a browser the browser may record the URL. Other examples of user actions include watching a video, deleting a video, uploading an audio, adding a user to a chat and removing a user from a chat. Other examples of a signal include an image, an image extracted from a video, an audio extracted from a video, a text, a text extracted from subtitles of a video, a captured audio signal, and a user action. Some signals are generated by a hardware processor, executing an application. For example, a mobile phone executing a client application of a social media platform. Another example is a computer executing a network connected game, connected to a gaming platform server.

There exist methods for detection of some aspects of toxic behavior. For example, there exist methods of detecting nudity in an image or a video. In addition, there exist methods for detecting a sentiment in a text, in a facial expression, and in an audio signal. Such methods analyze a signal, generated according to an action of a person, to detect an indication of toxic behavior in the signal. Some such methods compute for a signal one or more classifications, and associate each computed classification with a confidence value indicative of a likelihood of the classification. For example, a method for identifying nudity in an image may classify an image as containing nudity at an identified confidence value, for example a confidence value indicative of a 90% likelihood the image contains nudity. Such methods analyze each signal separately, and compute each classification independently of other classifications.

However, a nature of a social interaction may be derived from a combination of features detected in one or more signals. Moreover, an impact that a feature detected in a signal has on a deduction made regarding a social interaction may be increased by other features detected in the signal or in other signals. For example, when nudity is detected in an image and a child is identified in the image, a likelihood of the image being related to child abuse increases (even when the child themselves is not nude). In another example, a request to meet in real life may not in itself indicate an offending social interaction, for example when the request is sent from an adult to another adult. However, when a target of such a request is identified, possibly in another signal, as being a child, a request to meet in real life increases a likelihood that this request is part of an offending social interaction.

It may be the case that in analyzing a digital signal it is possible to identify sufficient features to correctly identify an offending social interaction. For example, there exist methods to identify a naked child in a digital image. However, there are many cases where a plurality of features that combine to identify a social interaction as offending cannot be detected in a single signal or at a single time. For example, in an ongoing conversation between two people, one message may comprise a first person revealing their age indicating they are a child. Another message, sometime after, may comprise an invitation from the second person to the first person to meet in real life. Existing methods that analyze signals separately cannot identify that the invitation in the other message is offending. In another example, in a chat group such as a WhatsApp group, a person may send a message to the chat group expressing a sentiment of being offended or scared. Analyzing just the message does not reveal what historical messages the person is responding to or who sent the historical messages. As a result, existing methods that analyze a single signal, or one or more signals at a given time, may fail to identify an offending social interaction, and additionally or alternatively may fail to identify a perpetrator of offensive (toxic) behavior.

A digital data signal may be associated with one or more entities, for example a person sending the digital data signal. Other examples of an entity related to a digital data signal are a target person identified in the digital data signal, for example a person named in a digital data signal comprising text, an application generating the digital data signal, and a chat the digital data signal is a part thereof. An entity may have a plurality of entity attributes, each indicative of a characteristic of the entity. In order to identify a nature of a social interaction, for example to identify an offending social interaction, there is a need to identify one or more characteristics of one or more entities associated with one or more signals composing the social interaction.

To do so, the present invention proposes, in some embodiments thereof, using a relationship tree describing a semantic relationship between a plurality of basic entity attributes identified in the one or more signals and a plurality of combination entity attributes of one or more entities to update one or more combination entity confidence values of at least one entity of the one or more entities associated with the one or more signals, and to determine one or more offending social interactions according to the at least one combination entity confidence value computed according to the relationship tree.

An example of a semantic relationship described by the relationship tree, between some basic entity attributes and a combination entity attribute, is an increased confidence that a person is a hunter, actively seeking a target person, when in one or more signals both a location (a first basic entity attribute) and an invitation to meet in real life (a second basic entity attribute) are identified. Optionally, each of the plurality of combination entity attributes, i.e. the plurality of entity characteristics, is associated with one of the plurality of combination entity confidence values, such that each combination entity confidence value is indicative of a degree of confidence the respective entity has the respective combination entity attribute. Some examples of a combination entity attribute are “associated with an insult”, “associated with a public interaction”, “is under an identified age”, and “is a pedophile”. Some examples of a basic entity attribute are “an insult detected”, “a physical location detected” and “sexual solicitation detected”.

Optionally, each of the one or more entities has a plurality of basic entity attributes, i.e. basic entity characteristics. Optionally, each of the plurality of basic entity attributes is associated with one of a plurality of basic entity confidence values indicative of a degree of confidence the one or more entities has the respective basic entity attribute. Optionally, the one or more combination entity confidence value is updated according to at least some of the plurality of basic entity confidence values, according to the relationship tree. Additionally, or alternatively, the one or more combination entity confidence value is updated according to one or more other combination entity confidence values, according to the relationship tree. Using a relationship tree to compute a combination entity confidence value allows integrating seemingly unrelated attributes, identified in the one or more signals, thus increasing accuracy of the combination entity confidence value and thus increasing accuracy of an identification of the offending social interaction. Optionally, the one or more offending social interactions are determined subject to the one or more combination entity confidence values exceeding a threshold confidence value, for example, when a combination entity confidence value associated with a chat characteristic of pedophilia exceeds 95%.

Optionally, the plurality of basic entity confidence values are computed by at least one hardware processor executing one or more signal classifiers, each trained to compute one or more signal classifications in response to one or more input signals. Optionally, updating the one or more combination entity confidence values comprises executing one or more combination classifiers, each trained to compute one or more combination classifications in response to a plurality of basic entity confidence values and another plurality of combination entity confidence values. Using one or more signal classifiers trained to compute one or more signal classifications increases accuracy of the plurality of basic entity confidence values. Additionally, or alternatively, using one or more combination classifiers each trained to compute one or more combination classifications increases accuracy of the plurality of combination entity confidence values. Increasing accuracy of the plurality of basic entity confidence values and additionally or alternatively increasing accuracy of the plurality of combination entity confidence values increases accuracy of determination of an offensive social interaction according thereto.

Optionally, the relationship tree describes a cascaded relationship between the plurality of basic entity attributes and the plurality of combination entity attributes, where at least some of the combination entity attributes are related to at least some other of the plurality of combination entity attributes, in addition or alternatively to being related to at least some of the plurality of basic entity attributes. Optionally, the one or more combination entity confidence values exceeding the threshold confidence value is updated further according to another combination entity confidence value, according to the cascaded relationship described by the relationship tree. Using a relationship tree comprising a cascaded relationship facilitates describing complex and inter-dependent relationships, increasing accuracy of describing the relationship between the plurality of basic entity attributes and the plurality of combination entity attributes, thus increasing accuracy of updating the one or more combination confidence values according to the relationship tree and thus increasing accuracy of determining the one or more offending social interactions.

Optionally, not all of the plurality of basic entity confidence values and the plurality of combination entity confidence values are updated at the same time. Optionally, at least some of the plurality of basic entity confidence values and the plurality of combination entity confidence values are each updated at one or more times in an identified time interval preceding a time of determining the one or more combination entity confidence values exceeds the threshold confidence value or a time of updating the one or more combination entity confidence values. For example, no earlier than a month prior to determining the one or more combination entity confidence values exceeds the threshold confidence value, or no more than 5 weeks prior to updating the one or more combination entity confidence values. Considering one or more entity confidence values (basic and additionally or alternatively combination entity confidence values) computed at different times facilitates identifying an offending nature of a social interaction where the offense is progressive and comprises a plurality of occurrences over time, increasing accuracy of identifying an offending social interaction compared to other methods that consider only simultaneous occurrences.

Optionally, in some embodiments thereof the present invention proposes performing one or more management tasks subject to determining the one or more offending social interactions. For example, when the one or more entity comprises a chat, a management task may be blocking communications on the chat, for example by instructing to decline sending one or more additional signals associated with chat. Another example of a management task is generating an alarm. Other examples of a management task include sending a message, storing an indication of non-volatile digital storage, and displaying another message on a display device. Performing a management task facilitates intervening in an offending interaction and mitigating negative implications of an offending interaction, for example increases ability to prevent self-harm by a person or prevent or reduce harm to another person.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments and additionally or alternatively of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

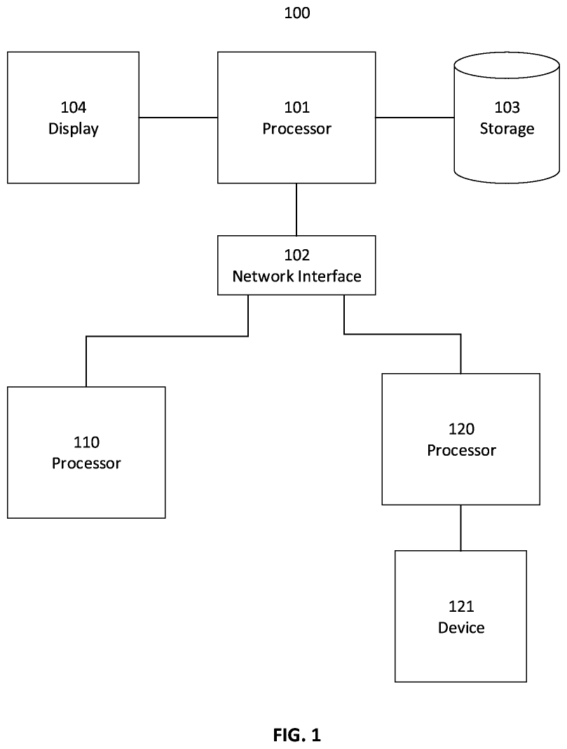

Reference is now made to FIG. 1, showing a schematic block diagram of an exemplary system 100, according to some embodiments of the present invention. In such embodiments, at least one hardware processor 101 is connected to one or more digital communication network interface 102, for example for the purpose of receiving one or more digital data signals. For brevity, henceforth the term “processor” is used to mean “at least one hardware processor” and the term “network interface” is used to mean “at least one digital communication network interface”. Optionally, network interface 102 is connected to a local area network (LAN), some examples being a wired LAN, for example an Ethernet LAN, and a wireless LAN, for example a WiFi LAN. Optionally, network interface is connected to a wide area network (WAN), for example a cellular WAN, for example a Global System for Mobile Communications (GSM) network or the Internet.

Optionally, another processor 110 is connected to processor 101, optionally for the purpose of sending processor 101 one or more signals, each generated according to an action of a person. Optionally, other processor 110 executes an application. For example, other processor 110 may be a mobile phone executing a client application of a social media platform. In another example, other processor 110 is a computer executing a network connected game, connected to a gaming platform server. Optionally, other processor 110 is connected to processor 101 via network interface 102. Optionally, other processor 110 is connected to processor 101 via an other digital communication interface, for example a common memory bus. Optionally, other processor 110 is processor 101.

Optionally, processor 101 is connected to at least one digital storage 103, for example for the purpose of storing the one or more signals received from other processor 110. Optionally, at least one digital storage 103 is non-volatile. Some examples of a non-volatile digital storage are a hard disk drive, a network storage, a storage network, and a non-volatile random access memory (NVRAM). Optionally, at least one digital storage 103 is volatile, for example a random access memory (RAM) component. For brevity, henceforth the term “storage” is used to mean “at least one digital storage”.

Optionally, processor 101 is connected to one or more display device 104, optionally for the purpose of displaying one or more messages. Some examples of a display device are a monitor, a segment display, a smart television, and a projector.

Optionally, an additionally other processor 120 is connected to processor 101, optionally via network interface 102, optionally for the purpose of processor 101 sending processor 120 one or more other messages. Optionally, additionally other processor 120 is connected to one or more devices 121, optionally for the purpose of outputting a signal in response to the one or more other messages received from processor 101. For example, one or more devices 121 may comprise another monitor. Optionally, one or more devices 121 comprise an audio device, capable of emitting a sound, for example an alarm, perceivable by a person monitoring an output of processor 120. Optionally, one or more devices 121 comprise a visual device, capable of emitting a visual signal, for example a flashing light, perceivable by the person monitoring the output of processor 120.

To process one or more digital data signals, system 100 implements, in some embodiments thereof, the following optional method.

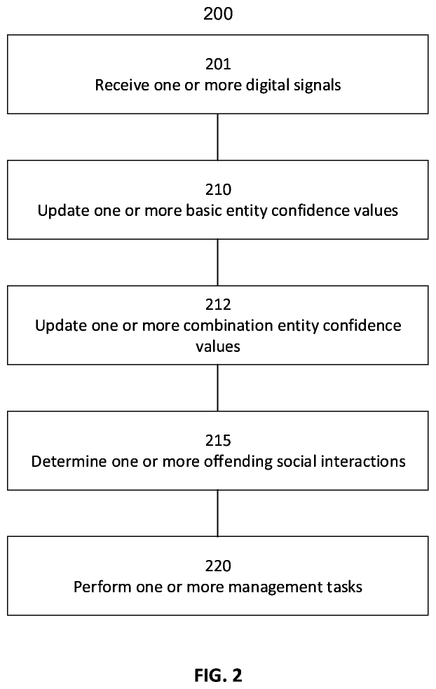

Reference is now made also to FIG. 2, showing a flowchart schematically representing an optional flow of operations 200 for identifying an offending social interaction, according to some embodiments of the present invention. In such embodiments, processor 101 receives in 201 one or more signals from other processor 110.

Optionally, each of the one or more signals is generated according to an action of a person. Optionally, each of the one or more signals is associated with one or more of a plurality of entities. Some examples of an entity are a person performing an action, a person who is a target of the action, an application, and a chat in an application. Some examples of an action of a person are accessing a universal resource location (URL) via a browser, watching a video, deleting a video, uploading an audio, adding a user to a chat and removing a user from a chat. An example of a signal generated according to an action of a user is a digital video generated on a platform when a user uploads a digital video to the platform. Another example is a digital signal comprising a message sent by a person sending the message in a chat group. Another example is periodically generated signals indicative of a person's location and sent to another hardware processor, for example a platform server, generated by an application executing on the person's device, for example the person's smartphone. Other examples of a signal include an image, an image extracted from a video, an audio extracted from a video, a text, a text extracted from subtitles of a video, a captured audio signal, and a user action.

Optionally, each entity of the plurality of entities has a plurality of basic entity confidence values of a plurality of basic entity attributes, and a plurality of combination entity confidence values of a plurality of combination entity attributes. A basic entity attribute may be indicative of a feature detected in a signal, some examples being: a user identifier, a signal identifier, an original signal identifier, indicative of another signal from which the signal is extracted, a chat framework identifier, a time, an amount of time, a defamation detected indication, a profanity detected indication, a location detected, an age detected, and a sexual intention detected. A combination entity attribute may be indicative of a computed deduction, for example a personal insult score, a racism score, a bullying score, a hunter score, a pedophile score, and a predator score. Optionally, a basic entity confidence value of a basic entity attribute is indicative of a likelihood of the respective entity having the basic entity attribute. Similarly, a combination entity confidence value of a combination entity attribute is optionally indicative of a likelihood of the respective entity having the combination entity attribute.

For one or more entities of the plurality of entities, in 210 processor 101 optionally updates one or more basic entity confidence values of the one or more entities according to a plurality of signal attribute values computed for the one or more signals. Optionally, the plurality of signal attribute values are computed by processor 101 executing one or more signal classifiers. Optionally, each of the one or more signal classifiers are trained to compute one or more signal classifications in response to one or more input signals. For example, a signal classifier may be trained to detect text having sexual nature (sexting) in a signal comprising text and classify the signal has having sexting. Some examples of a signal classifier are a neural network and a machine learning statistical model. In 212, processor 101 optionally updates one or more combination entity confidence values of the one or more entities using the plurality of basic entity confidence values and the plurality of combination confidence values of the one or more entities. Optionally, in 212, processor 101 updates the one or more combination entity confidence values according to a relationship tree describing a semantic relationship between the plurality of basic entity attributes and the plurality of combination entity attributes.

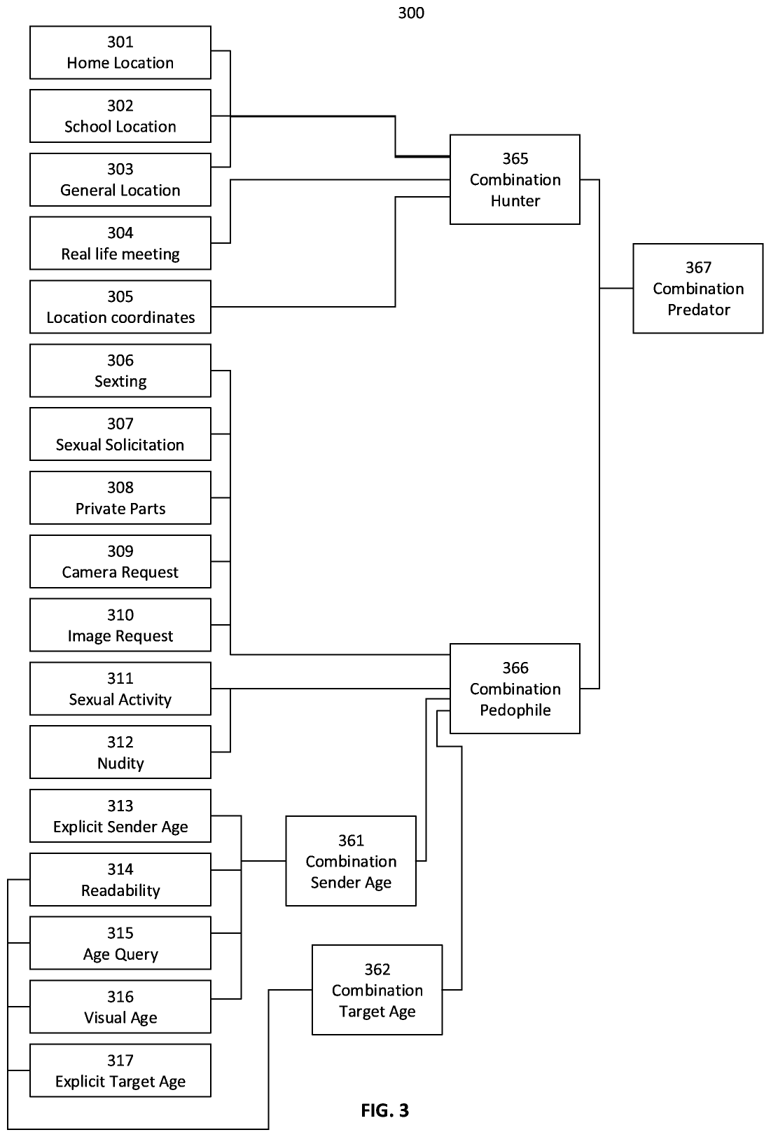

Reference is now made also to FIG. 3, showing a schematic block diagram of part of an exemplary relationship tree 300 as pertains to identifying a pedophilic nature of a social interaction, according to some embodiments of the present invention. In this example, home location 301 is a basic entity attribute indicative of a geographical location of a residence. The residence may be of a person performing an action according to which a signal was generated, for example a person sending a message. The residence may be of a target of the action according to which the signal was generated, for example a target person of the message. Optionally, the plurality of basic entity confidence values comprises a home location confidence value indicative of a degree of confidence of identifying home location 301 in the one or more signals.

Optionally, school location 302 is a basic entity attribute indicative of a geographical location of a school attended by a person. Optionally, the plurality of basic entity confidence values comprises a school location confidence value indicative of a degree of confidence of identifying school location 302 in the one or more signals. Optionally general location 303 is a basic entity attribute indicative of a geographical location, for example a geographical location of a meeting. Optionally, the plurality of basic entity confidence values comprises a general location confidence value indicative of a degree of confidence of identifying general location 303 in the one or more signals.

A geographical location may be an address. Optionally, a geographical location is an identifier, for example “Public School 512” or “Joe's Diner”. Optionally, a geographical location is identified in a signal comprising text. Optionally, the geographical location is identified indirectly, for example from a text such as “let us meet at my place”. Optionally, the geographical location is identified in a signal comprising Global Positioning System (GPS) coordinates. Optionally, the geographical location is identified as a location a person is physically present thereat. Optionally, the geographical location is identified as a location the person is not physically present thereat. Optionally, real life meeting request 304 is a basic entity attribute indicative of a request for a meeting in real life (MIRL). Optionally, the plurality of basic entity confidence values comprises a real life meeting confidence value indicative of a likelihood of identifying real life meeting request 304 in the one or more signals.

An offending social interaction optionally comprises a sender person, sending one or more messages and being a perpetrator of an offense, and a target person, being a target of the offense. Optionally, combination hunter 365 is a combination entity attribute indicative of a sender person of a social interaction actively seeking a target person. Optionally, the plurality of combination entity confidence values comprises a combination hunter confidence value indicative of a likelihood of the one or more entity having combination entity attribute combination hunter 365. Thus, the combination hunter confidence value is optionally indicative of a likelihood that a social interaction associated with the one or more entities comprises a sender person actively seeking a target person.

Optionally, updating in 212 the one or more combination entity confidence values according to the relationship tree comprises updating the combination hunter confidence value subject to a location confidence value and the real life meeting confidence value each exceeding the threshold confidence value. Optionally, the location confidence value is one or more of the home location confidence value, the school location confidence value and the general location confidence value. Optionally, the threshold confidence value is a value between 0 and 1. Optionally, the threshold confidence value is 0.85. Optionally, the threshold confidence value is 0.3. or 0.5. Optionally, the threshold confidence value is 0.75, 0.87, 0.88 or 0.92.

Optionally, the combination hunter confidence value is updated according to the relationship tree at an identified time. Optionally, the location confidence value and the real life meeting confidence value are each updated to exceed the threshold confidence value at one or more times in an identified time interval preceding the identified time, for example one month preceding the identified time. Other examples of an identified time interval are one week, one day, an identified amount of days, an identified amount of months and an identified amount of hours.

Optionally, location-coordinates 305 is a basic entity attribute indicative of one or more coordinates in an identified coordinate system, for example GPS coordinates. Optionally, the plurality of basic entity confidence values comprises a location-coordinates confidence value indicative of a likelihood of identifying location-coordinates 305 in the one or more signals. Optionally, updating in 212 the one or more combination entity confidence values according to the relationship tree comprises updating the combination hunter confidence value further subject to the location coordinates confidence value exceeding the threshold confidence value. Thus, location-coordinates 305 may be optional to identifying combination hunter 365. Optionally, the location-coordinates confidence value is updated to exceed the threshold confidence value at another time in the identified time interval preceding the identified time.

Optionally, explicit-sender-age 313 is a basic entity attribute indicative of an age of a person identified in a signal being greater than or equal to a sender age minimum value, for example 15, 18, 25, or 50. Optionally, the plurality of basic entity confidence values comprises an explicit-sender-age confidence value indicative of a degree of confidence of identifying explicit-sender-age 313 in the one or more signals. Optionally, explicit-sender-age 313 is identified in a signal comprising text.

Optionally, combination sender-age 361 is a combination entity attribute indicative of a sender person of a social interaction having an age greater or equal to the sender age minimum value. Optionally, the plurality of combination entity confidence values comprises a combination sender-age confidence value indicative of a likelihood of the one or more entity having a sender person having an age greater or equal to the sender age minimum value. Optionally, updating in 212 the one or more combination entity confidence values according to the relationship tree comprises updating the combination sender-age confidence value subject to the explicit-sender-age confidence value exceeding a threshold sender-age confidence value, for example 0.88.

Optionally, explicit-target-age 317 is a basic entity attribute indicative of an age of a person identified in a signal being less than or equal to a target age maximum value, for example 15, or 18. Optionally, the plurality of basic entity confidence values comprises an explicit-target-age confidence value indicative of a degree of confidence of identifying explicit-target-age 317 in the one or more signals. Optionally, explicit-target-age 317 is identified in a signal comprising text.

Optionally, combination target-age 362 is a combination entity attribute indicative of a target person of a social interaction having an age less than or equal to the target age maximum value. Optionally, the plurality of combination entity confidence values comprises a combination target-age confidence value indicative of a likelihood of the one or more entity having a target person having an age less than or equal to the target age maximum value. Optionally, updating in 212 the one or more combination entity confidence values according to the relationship tree comprises updating the combination target-age confidence value subject to the explicit-target-age confidence value exceeding a threshold target-age confidence value, for example 0.87.

Optionally, age-readability 314 is a basic entity attribute indicative of an age of a person identified according to a readability classification of text. For example, some grammatical structures identified in a text may be indicative of the text being written by a child. Alternatively, some other grammatical structures identified in the text may be indicative of the text being written by an adult. Optionally, the plurality of basic entity confidence values comprises an age-readability confidence value indicative of a degree of confidence of identifying age-readability 314 in the one or more signals. Optionally, age-readability 314 is identified in a signal comprising text.

Optionally, under-age-query 315 is a basic entity attribute indicative of a query for determining a person's age, for example a question regarding what grade at school a target person attends. Optionally, the plurality of basic entity confidence values comprises an under-age-query confidence value indicative of a degree of confidence of identifying under-age-query 315 in the one or more signals. Optionally, under-age-query 315 is identified in a signal comprising text.

Optionally, updating in 212 the one or more combination entity confidence values according to the relationship tree comprises updating the combination target-age confidence value or the combination sender-age confidence value or both subject to the under-age-query confidence value and additionally or alternatively the age-readability confidence value each exceeding the threshold confidence value.

Optionally, visual-age 316 is a basic entity attribute indicative of an age of a person identified in a digital image. Optionally, the plurality of basic entity confidence values comprises a visual-age confidence value indicative of a degree of confidence of identifying visual-age 316 in the one or more signals. Optionally, visual-age 316 is identified in a signal comprising one or more digital images. Optionally, updating in 212 the one or more combination entity confidence values according to the relationship tree comprises updating the combination target-age confidence value or the combination sender-age confidence value or both subject to the visual-age confidence value the exceeding the threshold confidence value.

Optionally, sexting 306 is a basic entity attribute indicative of text having a sexual nature. Optionally, the plurality of basic entity confidence values comprises a sexting confidence value indicative of a degree of confidence of identifying sexting 306 in the one or more signals.

Optionally, sexual-solicitation 307 is a basic entity attribute indicative of text having a sexual solicitation nature. Optionally, the plurality of basic entity confidence values comprises a sexual-solicitation confidence value indicative of a degree of confidence of identifying sexual-solicitation 307 in the one or more signals.

Optionally, private-parts 308 is a basic entity attribute indicative of text describing at least one body part in a set of private body parts. Optionally, the set of private body parts includes male genitalia, female genitalia, and breasts. Optionally, the plurality of basic entity confidence values comprises a private-parts confidence value indicative of a degree of confidence of identifying private-parts 308 in the one or more signals.

Optionally, camera-request 309 is a basic entity attribute indicative of a request to activate a digital camera. Optionally, the plurality of basic entity confidence values comprises a camera-request confidence value indicative of a degree of confidence of identifying camera-request 309 in the one or more signals.

Optionally, image-request 310 is a basic entity attribute indicative of a request to send one or more digital images. A digital image may be a still image. The one or more digital images may be a digital video. Optionally, the plurality of basic entity confidence values comprises an image-request confidence value indicative of a degree of confidence of identifying image-request 310 in the one or more signals.

Optionally, sexual content is identified in a signal comprising text, for example sexting 306, sexual-solicitation 307, private parts 308, camera request 309 and image request 310.

Optionally, combination pedophile 366 is a combination entity attribute indicative of a social interaction having a sexual nature and comprising an adult person and a child person. Optionally, the plurality of combination entity confidence values comprises a combination pedophile confidence value indicative of a likelihood of the one or more entity having combination entity attribute combination pedophile 366. Thus, the combination pedophile confidence value is optionally indicative of a likelihood that a social interaction associated with the one or more entities has a sexual nature and comprises an adult person and a child person. Optionally, updating in 212 the one or more combination entity confidence values according to the relationship tree comprises updating the combination pedophile confidence value subject to one or more sexual-content confidence values, one or more sexual-content-request confidence values, the combination sender-age confidence value and the combination target-age confidence value each exceeding the threshold confidence value. Optionally, a sexual-content confidence value is one of the sexting confidence value, the sexual-solicitation confidence value, and the private-parts confidence value. Optionally, a sexual-content-request confidence value is one of the camera-request confidence value and the image-request confidence value.

Optionally, sexual-activity 311 is a basic entity attribute indicative of sexual activity. Optionally, the plurality of basic entity confidence values comprises a sexual-activity confidence value indicative of a degree of confidence of identifying sexual-activity 311 in the one or more signals. Optionally, sexual-activity 311 is identified in a signal comprising one or more digital images.

Optionally, nudity 312 is a basic entity attribute indicative of nudity. Optionally, the plurality of basic entity confidence values comprises a nudity confidence value indicative of a degree of confidence of identifying nudity 312 in the one or more signals. Optionally, nudity 312 is identified in a signal comprising one or more digital images.

Optionally, updating in 212 the one or more combination entity confidence values according to the relationship tree comprises updating the combination pedophile confidence value further subject to one or more of the sexual-activity confidence value and the nudity confidence value each exceeding the threshold confidence value. Thus, nudity 311 may be optional to identifying combination pedophile 366, and sexual-activity 312 may be optional to identifying combination pedophile 366.

Optionally, the combination pedophile confidence value is updated according to the relationship tree at yet another identified time. Optionally, the sexting confidence value, the sexual-solicitation confidence value, the private-parts confidence value, the camera-request confidence value, and the image-request confidence value are each updated to exceed the threshold confidence value at yet one or more other times in yet another identified time interval preceding the yet other identified time.

Optionally, the yet other identified time interval is one of: a month, a week, an hour, a minute, an identified amount of minutes, an identified amount of hours, an identified amount of months, an identified amount of weeks, and an identified amount of days. Thus, one or more of the sexting confidence value, the sexual-solicitation confidence value, the private-parts confidence value, the camera-request confidence value, and the image-request confidence value were optionally updated within an identified amount of time before updating the combination pedophile confidence value.

Optionally, combination predator 367 is a combination entity attribute indicative of a social interaction comprising an adult person actively seeking a target child (minor) person. Optionally, the plurality of combination entity confidence values comprises a combination predator confidence value indicative of a likelihood of the one or more entity having combination entity attribute combination predator 367. Thus, the combination predator confidence value is optionally indicative of a likelihood that a social interaction associated with the one or more entities comprises an adult person actively seeking a minor person.

Optionally, updating in 212 the one or more combination entity confidence values according to the relationship tree comprises updating the combination predator confidence value subject to the combination hunter confidence value and the combination pedophile combination value exceeding the threshold confidence value. Optionally, the combination predator confidence value is updated according to the relationship tree at an additional other identified time. Optionally, the combination hunter confidence value and the combination pedophile confidence value are each updated to exceed the threshold confidence value at an additional other identified time interval preceding the additional other identified time. Optionally, the additional other identified time interval is one of: a minute, an hour, a month, a week, an identified amount of minutes, an identified amount of hours, an identified amount of months, an identified amount of weeks, and an identified amount of days.

Reference is now made again to FIG. 2. Optionally, updating the one or more combination entity confidence value comprises executing at least one combination classifier trained to compute one or more combination classifications in response to a plurality of basic entity confidence values and another plurality of combination entity confidence values. For example, a combination classifier may be trained to compute a combination predator confidence value in response to input comprising, but not limited to, a home location confidence value, a real life meeting request confidence value, a sexual solicitation confidence value and one or more combination age confidence values. Some examples of a combination classifier are a neural network and a machine learning statistical model.

Optionally, the one or more combination confidence values are updated according to the relationship tree at the identified time. Optionally, at least some of the plurality of basic entity confidence values and the plurality of combination entity confidence values contributing to updating the one or more combination entity confidence value according to the relationship tree are each updated to exceed the threshold confidence value at one or more times in the identified time interval preceding the identified time.

In 215, processor 101 optionally determines one or more offending social interactions subject to the one or more combination entity confidence values exceeding the threshold confidence value. For example, when the combination pedophile confidence value exceeds the threshold confidence value processor 101 may determine an offending social interaction. In 220, processor 101 optionally performs one or more management tasks subject to determining in 215 the one or more offending social interactions. Optionally, performing the one or more management tasks comprises instructing other processor 110 to decline sending one or more other additional signals associated with the one or more entities, for example for the purpose of terminating the social interaction. Optionally, performing the one or more management tasks comprises instructing additional other processor 120 to generate an alarm perceivable by a person monitoring an output of additional other processor 120, optionally using device 121, for example by emitting a visual signal or an audio signal. Optionally, performing the one or more management tasks comprises storing an indication of the one or more offending social interactions on storage 103. Optionally, performing the one or more management tasks comprises generating a message and sending the message to other processor 110, optionally generating the message to comprise the indication of the one or more offending social interactions. Optionally, performing the one or more management tasks comprises displaying another message on display 104.

In some embodiments of the present invention system 100 is a monitoring system for a digital social platform. In such embodiments, system 100 implements the following optional method.

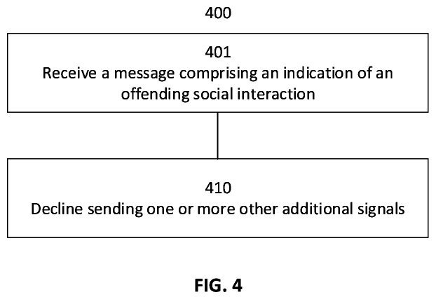

Reference is now made also to FIG. 4, showing a flowchart schematically representing an optional flow of operations 400 for a monitoring system, according to some embodiments of the present invention. In such embodiments, in 401 other processor 110 receives a message from processor 101 comprising an indication of an offending social interaction detected in one or more signals received from other processor 110. Optionally, system 100 implements method 200 to detect the offending social interaction. Optionally, in 410, other processor 110 declines sending one or more other additional signals, in response to receiving the message from processor 101.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant digital data signals, basic entity attributes and combination entity attributes will be developed and the scope of the terms “digital data signal”, “basic entity attribute” and “combination entity attribute” are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A system for processing digital data signals, comprising at least one hardware processor adapted for identifying an offending social interaction by:
receiving at least one signal from at least one other hardware processor, where each of the at least one signal is generated according to an action of a person and is associated with at least some of a plurality of entities, each entity having a plurality of basic entity confidence values of a plurality of basic entity attributes, and a plurality of combination entity confidence values of a plurality of combination entity attributes; and
for at least one entity of the plurality of entities:
updating at least one basic entity confidence value thereof according to a plurality of signal attribute values computed for the at least one signal;
updating at least one combination entity confidence value thereof, using the plurality of basic entity confidence values and the plurality of combination entity confidence values thereof, according to a relationship tree describing a semantic relationship between the plurality of basic entity attributes and the plurality of combination entity attributes;
determining at least one offending social interaction subject to the at least one combination entity confidence value exceeding a threshold confidence value; and
performing at least one management task subject to determining the at least one offending social interaction.

2. The system of claim 1, wherein the at least one combination entity confidence value is updated according to the relationship tree at an identified time; and
wherein at least some of the respective plurality of basic entity confidence values and the respective plurality of combination entity confidence values contributing to updating the at least one combination entity confidence value according to the relationship tree are each updated to exceed a threshold confidence value at one or more times in an identified time interval preceding the identified time.

3. The system of claim 1, wherein the at least one combination entity confidence value exceeding the threshold confidence value comprises a combination hunter confidence value indicative of a likelihood of a social interaction associated with the at least one entity comprises a sender person actively seeking a target person;
wherein the plurality of basic entity confidence values comprises:
at least one location confidence value selected from:
a home location confidence value, indicative of a degree of confidence of identifying, in at least one signal comprising text, a geographical location of a residence;
a school location confidence value, indicative of a degree of confidence of identifying, in the at least one signal comprising text, a geographical location of a school attended by the target person; and
a general location confidence value, indicative of a degree of confidence of identifying, in the at least one signal comprising text, a geographical location for a meeting; and
a real life meeting confidence value, indicative of a likelihood of identifying, in the at least one signal comprising text, a request for a meeting in real life; and
wherein updating the at least one combination entity confidence value according to the relationship tree comprises updating the combination hunter confidence value subject to the location confidence value and the real life meeting confidence value each exceeding the threshold confidence value.

4. The system of claim 3, wherein the combination hunter confidence value is updated according to the relationship tree at an identified time; and
wherein the location confidence value and the real life meeting confidence value are each updated to exceed the threshold confidence value at one or more times in an identified time interval preceding the identified time.

5. The system of claim 3,
wherein the plurality of basic entity confidence values further comprises:
a location-coordinates confidence value indicative of a likelihood of identifying, in the at least one signal comprising text, one or more coordinates in an identified coordinate system; and
wherein updating the at least one combination entity confidence value according to the relationship tree comprises updating the combination hunter confidence value further subject to the location-coordinates confidence value exceeding the threshold confidence value.

6. The system of claim 5, wherein the location-coordinates confidence value is updated to exceed the threshold confidence value at another time in the identified time interval preceding the identified time.

7. The system of claim 1, wherein the at least one combination entity confidence value exceeding the threshold confidence value comprises a combination pedophile confidence value indicative of a likelihood of another social interaction associated with the at least one entity having a sexual nature and comprising an adult person and a child person;
wherein the plurality of basic entity confidence values comprises:
at least one sexual-content confidence value selected from:
a sexting confidence value, indicative of a degree of confidence of identifying, in at least one signal comprising text, text having a sexual nature;
a sexual-solicitation confidence value, indicative of a degree of confidence of identifying, in the at least one signal comprising text, text having a sexual solicitation nature; and
a private-parts confidence value, indicative of a degree of confidence of identifying, in the at least one signal comprising text, text describing at least one body part in a set of private body parts;
at least one sexual-content-request confidence value selected from:
a camera-request confidence value, indicative of a degree of confidence of identifying, in at least one signal comprising text, a request to activate a digital camera; and
an image-request confidence value, indicative of a degree of confidence of identifying, in the at least one signal comprising text, a request to send one or more digital images;
wherein the plurality of combination entity confidence values comprises:
a combination sender-age confidence value, indicative of a likelihood that an age of the adult person is greater than or equal to a sender age minimum value; and
a combination target-age confidence value, indicative of a likelihood that another age of the child person is less than or equal to a target age maximum value; and
wherein updating the at least one combination entity confidence value according to the relationship tree comprises updating the combination pedophile confidence value subject to the at least one sexual-content confidence value, the at least one sexual-content-request confidence value, the combination sender-age confidence value, and the combination target-age confidence value each exceeding the threshold confidence value.

8. The system of claim 7, wherein the combination pedophile confidence value is updated according to the relationship tree at yet another identified time; and
wherein the sexting confidence value, the sexual-solicitation confidence value, the private-parts confidence value, the camera-request confidence value, and the image-request confidence value are each updated to exceed the threshold confidence value at yet one or more other times in yet another identified time interval preceding the yet other identified time.

9. The system of claim 7,
wherein the plurality of basic entity confidence values further comprises at least one of:
a sexual-activity confidence value indicative of a likelihood of identifying sexual activity in at least one other signal comprising at least one digital image; and
a nudity confidence value indicative of a likelihood of identifying nudity in the at least one other signal comprising the at least one digital image; and
wherein updating the at least one combination entity confidence value according to the relationship tree comprises updating the combination pedophile confidence value further subject to at least one of the sexual-activity confidence value and the nudity confidence value exceeding the threshold confidence value.

10. The system of claim 7,
wherein the plurality of basic entity confidence values further comprises:
an explicit-sender-age confidence value indicative of a likelihood that an age of a person identified in the at least one signal comprising text is greater than or equal to the sender age minimum value; and
an explicit-target-age confidence value indicative of a likelihood that another age of another person identified in the at least one signal comprising text is less than or equal to the target age maximum value; and
wherein updating the at least one combination entity confidence value according to the relationship tree comprises at least one of:
updating the combination sender-age confidence value subject to the explicit-sender-age confidence exceeding a sender-age confidence threshold; and
updating the combination target-age confidence value subject to the explicit-target-age confidence exceeding a target-age confidence threshold.

11. The system of claim 10,
wherein the plurality of basic entity confidence values further comprises:
an age readability confidence value indicative of a degree of confidence of identifying, in the at least one signal comprising text, an age according to a readability classification of the text; and
an under-age-query confidence value indicative of a degree of confidence of identifying, in the at least one signal comprising text, a query for determining a person's age; and
wherein updating the at least one combination entity confidence value according to the relationship tree comprises at least one of:
updating the combination sender-age confidence value subject to the age readability confidence value exceeding the threshold confidence value; and
updating the combination target-age confidence value subject to the under-age-query confidence value exceeding the threshold confidence value.

12. The system of claim 10, wherein the plurality of basic entity confidence values further comprises at least one visual-age confidence value indicative of a likelihood of identifying an age of at least one person identified in at least one other signal comprising at least one digital image; and
wherein updating the at least one combination entity confidence value according to the relationship tree comprises at least one of:
updating the combination sender-age confidence value subject to the at least one visual-age confidence value exceeding a sender-age confidence threshold; and
updating the combination target-age confidence value subject to the at least one visual-age confidence value exceeding a target-age confidence threshold.

13. The system of claim 1, wherein the at least one combination entity confidence value exceeding the threshold confidence value comprises a combination predator confidence value indicative of a likelihood of a social interaction associated with the at least one entity comprising an adult sender person actively seeking a target minor person;
wherein the plurality of combination entity confidence values comprises:
a combination hunter confidence value indicative of a likelihood of the social interaction comprising the adult sender person actively seeking the target minor person; and
a combination pedophile confidence value indicative of a likelihood of the social interaction having a sexual nature and comprising the adult sender person and the target minor person; and
wherein updating the at least one combination entity confidence value according to the relationship tree comprises updating the combination predator confidence value subject to the combination hunter confidence value and the combination pedophile confidence value each exceeding the threshold confidence value.

14. The system of claim 13, wherein the combination predator confidence value is updated according to the relationship tree at an additional other identified time; and
wherein the combination hunter confidence value, and the combination pedophile confidence value are each updated to exceed the threshold confidence value at one or more additional other times in an additional other identified time interval preceding the additional other identified time.

15. The system of claim 1, wherein updating the at least one combination entity confidence value comprises executing at least one combination classifier trained to compute at least one combination classification in response to a plurality of basic entity confidence values and another plurality of combination entity confidence values.

16. The system of claim 1, wherein the plurality of signal attribute values are computed by executing at least one signal classifier, trained to compute at least one signal classification in response to at least one input signal.

17. The system of claim 1, wherein performing the at least one management task comprises at least one of:
instructing at least one other hardware processor, connected to the at least one hardware processor, to decline sending one or more other additional signals associated with the at least one entity;
instructing at least one additional other hardware processor, connected to the at least one hardware processor, to generate an alarm perceivable by a person monitoring an output of the at least one additional other hardware processor;
sending a message to the at least one other hardware processor;
storing an indication of the at least one offending social interaction on at least one non-volatile digital storage connected to the at least one hardware processor; and
displaying another message on one or more display devices connected to the at least one hardware processor.

18. A method for processing digital data signals, comprising identifying an offending social interaction by:
receiving at least one signal from at least one hardware processor, where each of the at least one signal is generated according to an action of a person and is associated with at least some of a plurality of entities, each entity having a plurality of basic entity confidence values of a plurality of basic entity attributes, and a plurality of combination entity confidence values of a plurality of combination entity attributes; and
for at least one entity of the plurality of entities:
updating at least one basic entity confidence value thereof, using the plurality of basic entity confidence values and the plurality of combination entity confidence values thereof, according to a plurality of signal attribute values computed for the at least one signal;
updating at least one combination entity confidence value thereof according to a relationship tree describing a semantic relationship between the plurality of basic entity attributes and the plurality of combination entity attributes;
determining at least one offending social interaction subject to the at least one combination entity confidence value exceeding a threshold confidence value; and
performing at least one management task subject to determining the at least one offending social interaction.

19. A monitoring system, comprising at least one hardware processor adapted for:
receiving from at least one other hardware processor an indication of an offending social interaction, identified by:
receiving at least one signal from the at least one hardware processor, where each of the at least one signal is generated according to an action of a person and is associated with at least some of a plurality of entities, each entity having a plurality of basic entity confidence values of a plurality of basic entity attributes, and a plurality of combination entity confidence values of a plurality of combination entity attributes; and
for at least one entity of the plurality of entities:
updating at least one basic entity confidence value thereof according to a plurality of signal attribute values computed for the at least one signal;
updating at least one combination entity confidence value thereof, using the plurality of basic entity confidence values and the plurality of combination entity confidence values thereof, according to a relationship tree describing a semantic relationship between the plurality of basic entity attributes and the plurality of combination entity attributes;
determining at least one offending social interaction subject to the at least one combination entity confidence value exceeding a threshold confidence value; and
sending at least one message comprising an indication of the at least one offending social interaction; and
declining sending at least one other additional signals associated with the at least one entity.
